(19) United States
(12) Patent Application Publication
(10) Pub. No.: US 2025/0048158 A1
(43) Pub. Date: Feb. 6, 2025

(54) METHOD AND APPARATUS FOR EXECUTING PREDETERMINED OPERATION, COMMUNICATION DEVICE, AND STORAGE MEDIUM

(71) Applicant: Beijing Xiaomi Mobile Software Co., Ltd., Beijing (CN)

(72) Inventors: Ziquan HU, Beijing (CN); Xuhua TAO, Beijing (CN)

(73) Assignee: Beijing Xiaomi Mobile Software Co., Ltd., Beijing (CN)

(21) Appl. No.: 18/719,748

(22) PCT Filed: Dec. 14, 2021
(86) PCT No.: PCT/CN2021/138007

§ 371 Date: Jun. 13, 2024

(51) Int. Cl. H04W 24/10; H04B 17/318; H04W 76/27

(52) U.S. Cl. CPC H04W 24/10; H04B 17/328; H04W 76/27

(57) ABSTRACT

Embodiments of the present disclosure provide a method for performing a predetermined operation based on a measurement result of a non-cell defining synchronization signal block (NCD-SSB), being performed by a terminal. The method includes adjusting, according to offset indication information, a predetermined parameter for performing the predetermined operation based on the measurement result. The measurement result is obtained by performing a measurement operation based on the NCD-SSB, and the offset indication information is indicative of a measurement offset between a measurement operation performed based on a cell-defining synchronization signal block (CD-SSB) and the measurement operation performed based on the NCD-SSB.

### CROSS-REFERENCE TO RELATED APPLICATIONS

This application is a National Stage of International Application No. PCT/CN2021/138007, filed on Dec. 14, 2021, which is incorporated by reference herein in its entirety for all purposes.

### BACKGROUND

With the development of wireless communication networks, a reduced capability (RedCap) terminal type has been introduced. RedCap has the characteristics of low cost, low complexity and small size. Compared with enhanced mobile broadband (eMBB) terminals, RedCap terminals have reduced bandwidths, with the frequency range FRI being reduced to 20 MHz, and the frequency range FR2 being reduced to 100 MHz. In this way, due to the limited bandwidth of the RedCap terminal, there may be no corresponding cell-defining synchronization signal block (CD-SSB) within the terminal bandwidth, which may result in the inability to perform related measurement operations associated with SSB. In related art, the RedCap terminal can perform measurement operations based on non-cell defining SSB (NCD-SSB).

### SUMMARY

This disclosure relates to, but not limited to, the technical field of wireless communication, and in particular to a method, an apparatus, a communication device and a storage medium for performing a predetermined operation based on an NCD-SSB measurement result. Embodiments of this disclosure disclose a method, an apparatus, a communication device and a storage medium for performing a predetermined operation based on an NCD-SSB measurement result.

According to a first aspect of embodiments of this disclosure, a method for performing a predetermined operation based on a measurement result of an NCD-SSB is provided, which is performed by a terminal and includes:
adjusting, according to offset indication information, a predetermined parameter for performing the predetermined operation based on the measurement result;
where the measurement result is a result obtained by performing a measurement operation based on the NCD-SSB; and the offset indication information is information indicating a measurement offset between a measurement operation performed based on a CD-SSB and the measurement operation performed based on the NCD-SSB.

According to a second aspect of embodiments of this disclosure, a communication device is provided and includes:
a processor; and
a memory used for storing instructions executable by the processor,
where the processor, upon running the executable instructions, is configured to implement the method according to any embodiment of this disclosure.

According to a third aspect of embodiments of this disclosure, a computer storage medium is provided and used for storing computer-executable instructions which, upon being executed by a processor, is used for implementing the method according to any embodiment of this disclosure.

### BRIEF DESCRIPTION OF THE DRAWINGS

FIG. 1 is a schematic structural diagram of a wireless communication system according to an exemplary embodiment.

FIG. 2 is a schematic flowchart of a method for performing a predetermined operation based on an NCD-SSB measurement result according to an exemplary embodiment.

FIG. 3 is a schematic flowchart of a method for performing a predetermined operation based on an NCD-SSB measurement result according to an exemplary embodiment.

FIG. 4 is a schematic flowchart of a method for performing a predetermined operation based on an NCD-SSB measurement result according to an exemplary embodiment.

FIG. 5 is a schematic flowchart of a method for performing predetermined operations based on NCD-SSB measurement results according to an exemplary embodiment.

FIG. 6 is a schematic flowchart of a method for performing a predetermined operation based on an NCD-SSB measurement result according to an exemplary embodiment.

FIG. 7 is a schematic flowchart of a method for performing a predetermined operation based on an NCD-SSB measurement result according to an exemplary embodiment.

FIG. 8 is a schematic flowchart of a method for performing a predetermined operation based on an NCD-SSB measurement result according to an exemplary embodiment.

FIG. 9 is a schematic structural diagram of an apparatus for performing a predetermined operation based on an NCD-SSB measurement result according to an exemplary embodiment.

FIG. 10 is a schematic structural diagram of a terminal according to an exemplary embodiment.

FIG. 11 is a block diagram of a base station according to an exemplary embodiment.

### DETAILED DESCRIPTION

Reference will now be made in detail to the exemplary embodiments, examples of which are illustrated in the accompanying drawings. Where the following description refers to the accompanying drawings, the same numerals in different drawings refer to the same or similar elements unless otherwise indicated. The implementations described in the following exemplary embodiments do not represent all implementations consistent with the embodiments of this disclosure. Rather, they are merely examples of apparatuses and methods consistent with aspects of the disclosed embodiments as recited in the appended claims.

Terms used in the embodiments of this disclosure are for the purpose of describing specific embodiments only, and are not intended to limit the embodiments of this disclosure. As used in the examples of this disclosure and the appended claims, the singular forms “a” and “the” are also intended to include the plural forms unless the context clearly dictates otherwise. It should also be understood that the term “and/or” as used herein refers to and includes any and all possible combinations of one or more of the associated listed items.

It should be understood that although the embodiments of this disclosure may use the terms “first”, “second”, “third”, etc. to describe various information, the information should not be limited to these terms. These terms are only used to distinguish information of the same type from one another. For example, without departing from the scope of the embodiments of this disclosure, first information may also be called second information, and similarly, second information may also be called first information. Depending on the context, the word “if” as used herein may be interpreted as “upon” or “when” or “in response to determining that . . . ”

For the purpose of brevity and ease of understanding, the term “greater than” or “less than” is used herein when indicating a size relationship. However, those skilled in the art can understand that the term “greater than” may also cover the meaning of “greater than or equal to”, and “less than” may also cover the meaning of “less than or equal to”.

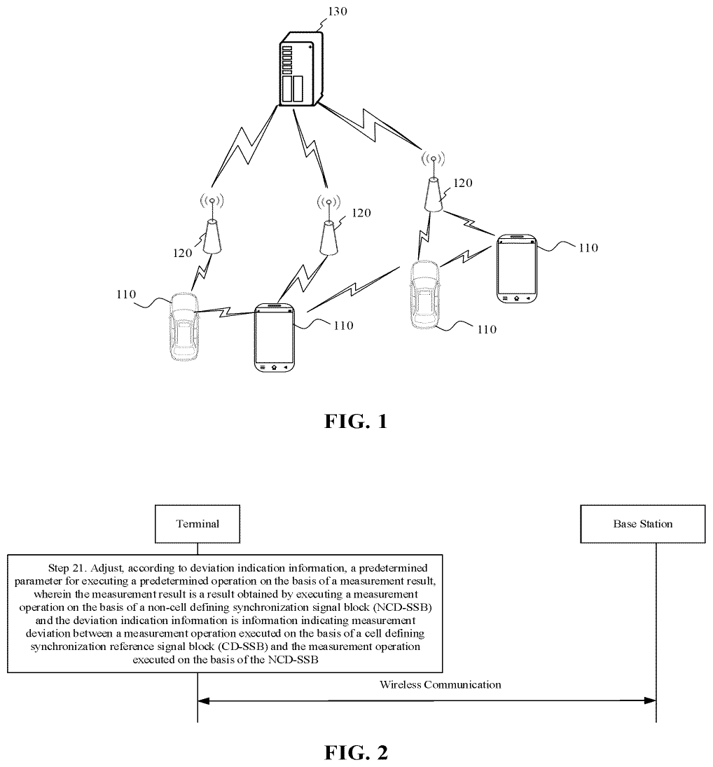

Referring to FIG. 1, which shows a schematic structural diagram of a wireless communication system according to an embodiment of this disclosure. As shown in FIG. 1, the wireless communication system is a communication system based on mobile communication technology, and the wireless communication system may include: several user equipments (UEs) 110 and several base stations 120.

In some embodiments, the UE 110 may be a device that provides voice and/or data connectivity to the user. The UE 110 can communicate with one or more core networks via a radio access network (RAN), and the UE 110 can be an Internet of things (IoT) UE, such as a sensor device, a mobile phone, and a computer with an IoT UE. For example, it may be a fixed, portable, pocket, hand-held, computer built-in, or vehicle-mounted device, such as station (STA), subscriber unit, subscriber station, mobile station, mobile, remote station, access point, remote terminal, access terminal, user terminal, user agent, user device, or user equipment. Alternatively, the UE 110 may also be equipment of an unmanned aerial vehicle. Alternatively, the UE 110 may also be a vehicle-mounted device, for example, a trip computer with a wireless communication function, or a wireless user device connected externally to the trip computer. Alternatively, the UE 110 may also be a roadside device, for example, a street lamp, a signal lamp, or other roadside devices with a wireless communication function.

The base station 120 may be a network side device in the wireless communication system. In some embodiments, the wireless communication system may be the 4th generation mobile communication (4G) system, also known as the Long Term Evolution (LTE) system. Alternatively, the wireless communication system may also be the 5G system, also known as new air interface system or 5G NR system. Alternatively, the wireless communication system may also be a next-generation system of the 5G system. In some embodiments, the access network in the 5G system can be called NG-RAN (New Generation-Radio Access Network).

In some embodiments, the base station 120 may be an evolved node-B (eNB) adopted in the 4G system. Alternatively, the base station 120 may also be a gNB adopting a centralization-distributed architecture in the 5G system. When the base station 120 adopts the centralization-distributed architecture, it generally includes a central unit (CU) and at least two distributed units (DUs). The CU is provided with a packet data convergence protocol (PDCP) layer, a radio link layer (RLC) protocol layer, a media access control (MAC) layer protocol stack; and the DU is provided with a physical (PHY) layer protocol stack. Embodiments of this disclosure do not limit the specific implementation of the base station 120.

A wireless connection may be established between the base station 120 and the UE 110 through a wireless air interface. In different embodiments, the wireless air interface is a wireless air interface based on the 4G standard; alternatively, the wireless air interface is a wireless air interface based on the 5G standard, for example, a new air interface; alternatively, the wireless air interface may also be a wireless air interface based on a technical standard of a next-generation mobile communication network based on 5G.

In some embodiments, an E2E (End to End) connection may also be established between UEs 110, for example, in the scenarios including V2V (vehicle to vehicle) communication, V2I (vehicle to Infrastructure) communication and V2P (vehicle to pedestrian) communication in V2X (vehicle to everything) communication.

Here, the forgoing UE may be regarded as the terminal device in the following embodiments.

In some embodiments, the foregoing wireless communication system may further include a network management device 130.

Several base stations 120 are connected to the network management device 130 respectively. In some embodiments, the network management device 130 may be a core network device in the wireless communication system, for example, the network management device 130 may be a MME (Mobility Management Entity) in an EPC (Evolved Packet Core) network. Alternatively, the network management device can also be other core network devices, such as SGW (Serving Gate Way), PGW (Public Data Network Gate Way), PCRF (Policy and Charging Rules Function), HSS (Home Subscriber Server), or the like. The implementation manner of the network management device 130 is not limited in embodiments of this disclosure.

In order to facilitate the understanding of those skilled in the art, the embodiments of this disclosure list a plurality of implementation manners to clearly illustrate the technical solutions according to some embodiments of this disclosure. Those skilled in the art can understand that the multiple implementation manners provided by the embodiments of this disclosure can be executed independently, or combined with the methods of other implementation manners in the embodiments of this disclosure, and can also be executed alone or in combination together with some other methods in related art, which is not limited in the embodiments of this disclosure.

In order to better understand the technical solution described in any embodiment of this disclosure, the scenario of terminal measurement in related art is described first.

In some embodiments, the base station can flexibly configure time-frequency domain positions to transmit multiple different synchronization signal blocks (SSBs), and SSBs transmitted at different frequency positions can have different physical cell identifications (PCIs). When an SSB is associated with the remaining minimum system information (RMSI), the SSB is called the cell defining SSB (CD-SSB). Based on an existing protocol, when the terminal performs related measurement operations based on SSB, the CD-SSB is always adopted. Here, related measurement operations include but are not limited to radio resource management (RRM) measurement, radio link monitoring (RLM) measurement, adjusted beam failure detection (BFD) measurement, physical layer reference signal received power (L1-RSRP) measurement, and the like.

In some embodiments, the SSB-based related measurements (e.g., RRM, RLM, BFD, L1-RSRP measurements, and the like) are all based on CD-SSB. After introducing measurements based on NCD-SSB, configuration parameters related to measurement operations may also need to be modified.

In some embodiments, when the base station transmits CD-SSB, it adopts the SSB power boosting feature, where the traffic channel power may be used to compensate the CD-SSB transmit power, so as to increase the public channel coverage distance and improve the wide coverage capability. At this time, if the terminal performs measurement based on NCD-SSB, because NCD-SSB does not have power boosting, it will lead to offset in measurement results.

As shown in FIG. 2, this embodiment provides a method for performing a predetermined operation based on NCD-SSB measurement result, where the method is performed by a terminal and includes following content.

In step 21, a predetermined parameter for performing a predetermined operation based on the measurement result is adjusted according to offset indication information.

Herein, the measurement result is a result obtained by performing a measurement operation based on the NCD-SSB; and the offset indication information is information indicating a measurement offset between a measurement operation performed based on CD-SSB and the measurement operation performed based on the NCD-SSB.

In some embodiments, the terminals involved in this disclosure may be, but not limited to, mobile phones, wearable devices, vehicle-mounted terminals, road side units (RSUs), smart home terminals, industrial sensing devices, and/or medical devices. In some embodiments, the terminal may be a terminal in an RRC connected state, or a terminal in an RRC non-connected state. The RRC non-connected state includes an RRC idle state and an RRC inactive state.

The base station involved in this disclosure may be an access device for a terminal to access a network. Here, the base station may be various types of base stations, for example, a base station of a third-generation mobile communication (3G) network, a base station of a 4G network, a base station of a 5G network, or other evolved base stations.

In some embodiments, the base station sends NCD-SSB configuration information to the terminal, where the configuration information may include the offset indication information. After receiving the configuration information, the terminal adjusts, according to the offset indication information, the predetermined parameter for performing the predetermined operation based on the measurement result. Herein, the measurement result is a result obtained by performing a measurement operation based on the NCD-SSB; and the offset indication information is information indicating a measurement offset between a measurement operation performed based on CD-SSB and the measurement operation performed based on the NCD-SSB.

In some embodiments, the predetermined parameter includes at least one of the following: a measurement result parameter of the measurement result; a threshold parameter of an execution condition used for performing the predetermined operation; and a reference parameter of an execution condition used for performing the predetermined operation.

In some embodiments, before adjusting the predetermined parameter for performing the predetermined operation based on the measurement result according to the offset indication information, the terminal performs the measurement operation to obtain the measurement result. Here, the measurement operation may be an operation of measuring reference signal received power (RSRP), reference signal received quality (RSRQ), signal to interference plus noise ratio (SINR), or the like. The predetermined operation may be, but not limited to, RRM measurement, RLM measurement, BFD measurement, L1-RSRP measurement, or the like.

In some embodiments, the predetermined operation may include at least one of the following: cell selection based on S-criterion; cell reselection based on a cell reselection measurement criterion; cell ranking based on R-ranking criterion; and measurement relaxation based on a measurement relaxation criterion.

In some embodiments, the base station transmits the configuration information of NCD-SSB to the terminal, where the configuration information includes the offset indication information indicating an RSRP offset between the measurement operation performed based on CD-SSB and the measurement operation performed based on NCD-SSB. Herein, the offset indication information may indicate an RSRP offset value. After receiving the configuration information, the terminal can adjust a measurement result parameter of the RSRP measurement result based on the RSRP offset value, and obtain the adjusted measurement result parameter of the RSRP measurement result.

In some embodiments, if the predetermined operation is a cell selection operation based on S-criterion, the measurement result parameter before adjustment may be:

$$Srxlev = {Q}_{rxlevmeas} - ( {Q}_{rxlevmin} + {Q}_{rxlevminoffset} ) - {P}_{compensation} - {Qoffset}_{t e m p}$$

The adjusted measurement result parameter may be:

$$Srxlev = {Q}_{rxlevmeas} - ( {Q}_{rxlevmin} + {Q}_{rxlevminoffset} ) - {P}_{compensation} - {Qoffset}_{t e m p} + rsrpOffsetNCDSSB .$$

Here, rsrpOffsetNCDSSB is the RSRP offset.

In some embodiments, if the operation is a cell reselection operation based on a cell reselection measurement criterion, the measurement result parameter before adjustment may be:

$$Srxlev = {Q}_{rxlevmeas} - ( {Q}_{rxlevmin} + {Q}_{rxlevminoffset} ) - {P}_{compensation} - {Qoffset}_{t e m p}$$

The adjusted measurement result parameters may be:

$$Srxlev = {Q}_{rxlevmeas} - ( {Q}_{rxlevmin} + {Q}_{rxlevminoffset} ) - {P}_{compensation} - {Qoffset}_{t e m p} + rsrpOffsetNCDSSB$$

Here, rsrpOffsetNCDSSB is the RSRP offset.

In some embodiments, if the operation is cell ranking based on R-ranking criterion, the measurement result parameter before adjustment may be:

$${R}_{s} = {Q}_{m e a s , s} + {Q}_{hyst} - {Q}_{offsettemp}$$

The adjusted measurement result parameter may be:

$${R}_{s} = {Q}_{meas , s} + {Q}_{hyst} - {Q}_{offsettemp} + rsrpOffsetNCDSSB$$

Here, rsrpOffsetNCDSSB is the RSRP offset.

In some embodiments, if the operation is measurement relaxation based on a measurement relaxation criterion, the measurement result parameter before adjustment may be:

$$Srxlev = {Q}_{rxlevmeas} - ( {Q}_{rxlevmin} + {Q}_{rxlevminoffset} ) - {P}_{compensation} - {Qoffset}_{temp}$$

The adjusted measurement result parameter may be:

$$Srxlev = {Q}_{rxlevmeas} - ( {Q}_{rxlevmin} + {Q}_{rxlevminoffset} ) - {P}_{compensation} - {Qoffset}_{temp} + rsrpOffsetNCDSSB$$

Here, rsrpOffsetNCDSSB is the RSRP offset.

In some embodiments, if the terminal is in the RRC connected state, at least one of the following predetermined operations may be performed based on the adjusted RSRP measurement result parameter: RRM measurement and L1-RSRP measurement.

In some embodiments, the configuration information of NCD-SSB is sent to the terminal, where the configuration information includes the offset indication information indicating an RSRP offset between the measurement operation performed based on CD-SSB and the measurement operation performed based on NCD-SSB. Herein, the offset indication information may indicate an RSRP offset value. After receiving the configuration information, the terminal can adjust, based on the RSRP offset value, a threshold parameter or a reference parameter of an execution condition used for performing the predetermined operation, and obtain the adjusted execution condition used for performing the predetermined operation.

In some embodiments, if the predetermined operation is cell selection based on S-criterion, the threshold parameter before adjustment is 0.

Exemplarily, the execution condition before adjustment includes Srxlev>0, and the adjusted execution condition includes: Srxlev+rsrpOffsetNCDSSB>0. Accordingly, it can be understood that the threshold parameter before adjustment is 0, and the adjusted threshold parameter is-rsrpOffsetNCDSSB. Here, rsrpOffsetNCDSSB is the RSRP offset.

In some embodiments, if the predetermined operation is cell reselection based on a cell reselection measurement criterion, the threshold parameter is SintraSearchP.

Exemplarily, a predetermined condition before adjustment includes: Srxlev>SintraSearchP. The adjusted predetermined condition includes: Srxlev+rsrpOffsetNCDSSB>SintraSearchP. Accordingly, it can be understood that the threshold parameter before adjustment is SintraSearchP, and the threshold parameter after adjustment is SintraSearchP-rsrpOffsetNCDSSB.

In some embodiments, if the predetermined operation is cell ranking based on R-ranking criterion, the reference parameter may be X, and the adjusted reference parameter is X=Rs+rsrpOffsetNCDSSB (offset value).

Exemplarily, the reference parameter before adjustment is Rs; and the adjusted reference parameter is Rs+rsrpOffsetNCDSSB. Here, rsrpOffsetNCDSSB is the RSRP offset.

In some embodiments, if the predetermined operation is measurement relaxation based on a measurement relaxation criterion, the threshold parameter is SSearch ThresholdP.

Exemplarily, the predetermined condition before adjustment includes: Srxlev>SSearchThresholdP; and the adjusted predetermined condition includes: Srxlev+rsrpOffsetNCDSSB>SSearchThresholdP. Here, it can be understood that the threshold parameter before adjustment is SSearchThresholdP, and the adjusted threshold parameter is: SSearch ThresholdP-rsrpOffsetNCDSSB.

In some embodiments, the configuration information of NCD-SSB is sent to the terminal, where the configuration information includes the offset indication information indicating an RSRQ offset between the measurement operation performed based on CD-SSB and the measurement operation performed based on NCD-SSB. Herein, the offset indication information may indicate an RSRQ offset value. After receiving the configuration information, the terminal can adjust a measurement result parameter of the RSRQ measurement result based on the RSRQ offset value, and obtain the adjusted measurement result parameter of the RSRQ measurement result.

In some embodiments, if the terminal is in the RRC non-connected state, at least one of the following predetermined operations can be performed based on the adjusted measurement result parameter of the RSRQ measurement result: cell selection based on S-criterion; cell reselection based on a cell reselection measurement criterion; cell ranking based on R-ranking criterion; and measurement relaxation based on a measurement relaxation criterion.

In some embodiments, if the predetermined operation is a cell selection operation based on S-criterion, the measurement result parameter before adjustment may be:

$$Squal = {Q}_{qualmeas} - ( {Q}_{qualmin} + {Q}_{qualminoffset} ) - {Q}_{offsettemp}$$

The adjusted measurement result parameter may be:

$$Squal = {Q}_{qualmeas} - ( {Q}_{qualmin} + {Q}_{qualminoffset} ) - {Q}_{offsettemp} + rsrqOffsetNCDSSB .$$

Here, rsrqOffsetNCDSSB is the RSRQ offset.

In some embodiments, if the predetermined operation is a cell reselection operation based on a cell reselection measurement criterion, the measurement result parameter before adjustment may be:

$$Squal = {Q}_{qualmeas} - ( {Q}_{qualmin} + {Q}_{qualminoffset} ) - {Q}_{offsettemp}$$

The adjusted measurement result parameters may be:

$$Squal = {Q}_{qualmeas} - ( {Q}_{qualmin} + {Q}_{qualminoffset} ) - {Q}_{offsettemp} + rsrqOffsetNCDSSB$$

Here, rsrqOffsetNCDSSB is the RSRQ offset.

In some embodiments, if the predetermined operation is cell ranking based on R-ranking criterion, the measurement result parameter before adjustment may be:

$${R}_{n} = {Q}_{meas , n} - {Q}_{offset} - {Q}_{offsettemp}$$

The adjusted measurement result parameter may be:

$${R}_{n} = {Q}_{meas , n} - {Q}_{offset} - {Q}_{offsettemp} + rsrqOffsetNCDSSB$$

Here, rsrqOffsetNCDSSB is the RSRQ offset.

Exemplarily, if the predetermined operation is measurement relaxation based on a measurement relaxation criterion, the measurement result parameter before adjustment may be:

$$Squal = {Q}_{qualmeas} - ( {Q}_{qualmin} + {Q}_{qualminoffset} ) - {Q}_{offsettemp}$$

The adjusted measurement result parameter may be:

$$Squal = {Q}_{qualmeas} - ( {Q}_{qualmin} + {Q}_{qualminoffset} ) - {Q}_{offsettemp} + rsrqOffsetNCDSSB$$

Here, rsrqOffsetNCDSSB is the RSRQ offset.

In some embodiments, if the terminal is in the RRC connected state, RRM measurement may be performed based on the adjusted RSRQ measurement result parameter.

In some embodiments, the configuration information of NCD-SSB is sent to the terminal, where the configuration information includes the offset indication information indicating an RSRQ offset between the measurement operation performed based on CD-SSB and the measurement operation performed based on NCD-SSB. Herein, the offset indication information may indicate an RSRQ offset value. After receiving the configuration information, the terminal can adjust, based on the RSRQ offset value, a threshold parameter or a reference parameter of an execution condition used for performing the predetermined operation, and obtain the adjusted execution condition used for performing the predetermined operation.

In some embodiments, if the terminal is in the RRC non-connected state, at least one of the following predetermined operations can be performed based on the adjusted execution condition: cell selection based on S-criterion; cell reselection based on a cell reselection measurement criterion; cell ranking based on R-ranking criterion; and measurement relaxation based on a measurement relaxation criterion.

In some embodiments, if the predetermined operation is cell selection based on S-criterion, the threshold parameter before adjustment is 0.

Exemplarily, a predetermined condition before adjustment includes Squal>0, and the adjusted predetermined condition includes: Squal+rsrqOffsetNCDSSB>0. Accordingly, it can be understood that the threshold parameter before adjustment is 0, and the threshold parameter after adjustment is-rsrqOffsetNCDSSB. Here, rsrqOffsetNCDSSB is the RSRQ offset.

In some embodiments, if the predetermined operation is cell reselection based on a cell reselection measurement criterion, the threshold parameter is SintraSearchQ.

Exemplarily, the predetermined condition before adjustment includes: Squal>SintraSearchQ. The adjusted predetermined condition includes: Squal+rsrqOffsetNCDSSB>SintraSearchQ. Accordingly, it can be understood that the threshold parameter before adjustment is SintraSearchQ, and the adjusted threshold parameter is SintraSearchQ-rsrqOffsetNCDSSB. Here, rsrqOffsetNCDSSB is the RSRQ offset.

In some embodiments, if the predetermined operation is cell ranking based on R-ranking criterion, the reference parameter may be X, and, after adjustment, X=Rn+rsrqOffsetNCDSSB (offset value).

Exemplarily, the reference parameter before adjustment is Rn; and the adjusted reference parameter is Rn+rsrqOffsetNCDSSB. Here, rsrqOffsetNCDSSB is the RSRQ offset.

In some embodiments, if the predetermined operation is measurement relaxation based on a measurement relaxation criterion, the threshold parameter is SSearch ThresholdQ.

Exemplarily, the predetermined condition before adjustment includes: Squal>SSearchThresholdQ; and the adjusted predetermined condition includes: Squal+rsrqOffsetNCDSSB>SSearchThresholdQ. Here, it can be understood that the threshold parameter before adjustment is SSearchThresholdQ, and the adjusted threshold parameter is: SSearchThresholdQ-rsrqOffsetNCDSSB. Here, rsrqOffsetNCDSSB is the RSRQ offset.

In some embodiments, the configuration information of NCD-SSB is sent to the terminal, where the configuration information includes the offset indication information indicating an SINR offset between the measurement operation performed based on CD-SSB and the measurement operation performed based on NCD-SSB. Here, the offset indication information may indicate an SINR offset value. After receiving the configuration information, the terminal can adjust, based on the SINR offset value, the measurement result parameter of the SINR measurement result, and obtain the adjusted measurement result parameter of the SINR measurement result.

In some embodiments, if the terminal is in the RRC connected state, RLM measurement and BFD measurement may be performed based on the adjusted measurement result parameter of the SINR measurement result.

In some embodiments, the configuration information of NCD-SSB is sent to the terminal, where the configuration information includes the offset indication information indicating a transmit power offset between the measurement operation performed based on CD-SSB and the measurement operation performed based on NCD-SSB. Here, the offset indication information may indicate a transmit power offset value. After receiving the configuration information, the terminal can determine at least one of RSRP offset, RSRQ offset and SINR offset based on the transmit power offset.

According to some embodiments of this disclosure, a predetermined parameter for performing the predetermined operation based on the measurement result is adjusted according to offset indication information, where the measurement result is a result obtained by performing a measurement operation based on the NCD-SSB, and the offset indication information is information indicating a measurement offset between a measurement operation performed based on a CD-SSB and the measurement operation performed based on the NCD-SSB. Here, since the offset indication information indicates information on the measurement offset between the measurement operation performed based on the CD-SSB and the measurement operation performed based on the NCD-SSB, after obtaining the result of performing the measurement operation based on the NCD-SSB, the predetermined parameter for performing the predetermined operation based on the measurement result can be adjusted. Compared to a manner in which the predetermined parameter for performing the predetermined operation based on the measurement result is not adjusted, the scenario where the measurement operation is performed based on the NCD-SSB can be better adapted, thereby making it more accurate and reliable to perform the predetermined operation according to the measurement result obtained by performing the measurement operation based on the NCD-SSB.

It should be noted that those skilled in the art can understand that the methods according to some embodiments of this disclosure may be executed independently, or together with some methods according to some other embodiments of this disclosure or some methods

In some embodiments, the predetermined parameter includes at least one of the following:
a measurement result parameter of the measurement result;
a threshold parameter of an execution condition used for performing the predetermined operation; and
a reference parameter of an execution condition used for performing the predetermined operation.

In some embodiments, the offset indication information includes at least one of the following:
information on a power offset between the measurement operation performed based on the CD-SSB and the measurement operation performed based on the NCD-SSB;
information on an RSRP offset between the measurement operation performed based on the CD-SSB and the measurement operation performed based on the NCD-SSB;
information on an RSRQ offset between the measurement operation performed based on the CD-SSB and the measurement operation performed based on the NCD-SSB; and
information on an SINR offset between the measurement operation performed based on the CD-SSB and the measurement operation performed based on the NCD-SSB.

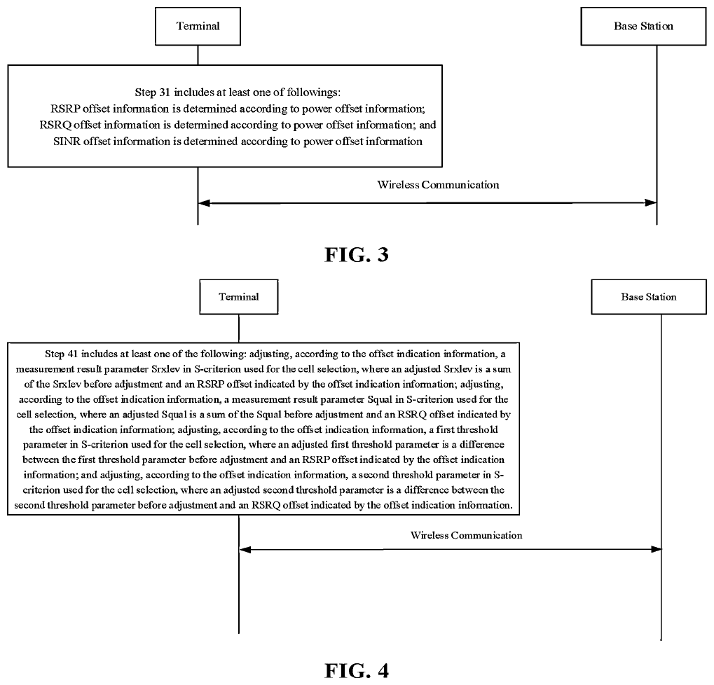

As shown in FIG. 3, this embodiment provides a method for performing a predetermined operation based on the NCD-SSB measurement result, where the method is performed by a terminal and includes step 31. Step 31 includes at least one of the following:
RSRP offset information is determined according to power offset information;
RSRQ offset information is determined according to power offset information; and
SINR offset information is determined according to power offset information.

Here, an offset value indicated by the RSRP offset information may be determined according to an offset value indicated by the power offset information. In some embodiments, the offset value indicated by the RSRP offset information may be determined, based on a mapping relationship between powers and RSRPs, according to the offset value indicated by the power offset information.

Here, an offset value indicated by the RSRQ offset information may be determined according to an offset value indicated by the power offset information. In some embodiments, the offset value indicated by the RSRQ offset information may be determined, based on a mapping relationship between powers and RSRQs, according to the offset value indicated by the power offset information.

Here, an offset value indicated by the SINR offset information may be determined according to an offset value indicated by the power offset information. In some embodiments, the offset value indicated by the SINR offset information may be determined, based on a mapping relationship between powers and SINRs, according to the offset value indicated by the power offset information.

It should be noted that those skilled in the art can understand that the methods according to some embodiments of this disclosure may be executed independently, or together with some methods according to some other embodiments of this disclosure or some methods in related art.

In some embodiments, the terminal is in the RRC non-connected state, and the predetermined operation is cell selection.

As shown in FIG. 4, this embodiment provides a method for performing a predetermined operation based on the NCD-SSB measurement result, where the terminal is in the RRC non-connected state, and the predetermined operation is cell selection. The method is performed by the terminal and includes step 41. Step 41 includes at least one of the following:
adjusting, according to the offset indication information, a measurement result parameter Srxlev in S-criterion used for the cell selection, where an adjusted Srxlev is a sum of the Srxlev before adjustment and an RSRP offset indicated by the offset indication information;
adjusting, according to the offset indication information, a measurement result parameter Squal in S-criterion used for the cell selection, where an adjusted Squal is a sum of the Squal before adjustment and an RSRQ offset indicated by the offset indication information;
adjusting, according to the offset indication information, a first threshold parameter in S-criterion used for the cell selection, where an adjusted first threshold parameter is a difference between the first threshold parameter before adjustment and an RSRP offset indicated by the offset indication information; and
adjusting, according to the offset indication information, a second threshold parameter in S-criterion used for the cell selection, where an adjusted second threshold parameter is a difference between the second threshold parameter before adjustment and an RSRQ offset indicated by the offset indication information.

In some embodiments, when performing cell selection, the terminal executes S-criterion to determine whether the cell is suitable for residing. Herein, the measurement result obtained by measurement using NCD-SSB is to be compensated when the S-criterion is executed. In this disclosure, the compensation may include adjustment of S-criterion based on the offset indication information.

Exemplarily, after adjustment, it may be:
Srxlev+rsrpOffsetNCDSSB>0 AND Squal+rsrqOffsetNCDSSB>0, where the first threshold parameter and the second threshold parameter are both 0;
or,

$$Srxlev = {Q}_{rxlevmeas} - ( {Q}_{rxlevmin} + {Q}_{rxlevminoffset} ) - {P}_{compensation} - {Qoffset}_{temp} + rsrpOffsetNCDSSB ;$$

$$Squal = {Q}_{qualmeas} - ( {Q}_{qualmin} + {Q}_{qualminoffset} ) - {Q}_{offsettemp} + rsrqOffsetNCDSSB ,$$

where rsrpOffsetNCDSSB is the RSRP offset, and rsrqOffsetNCDSSB is the RSRQ offset.

It should be noted that those skilled in the art can understand that the methods according to some embodiments of this disclosure may be executed independently, or together with some methods according to some other embodiments of this disclosure or some methods in related art.

In some embodiments, the terminal is in the RRC non-connected state, and the predetermined operation is cell reselection.

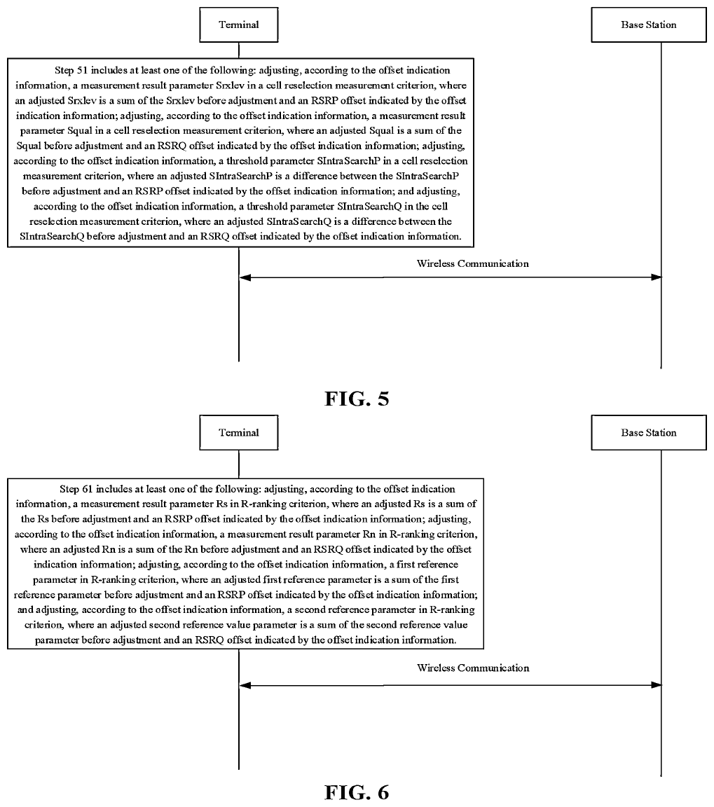

As shown in FIG. 5, this embodiment provides a method for performing a predetermined operation based on the NCD-SSB measurement result, where the terminal is in the RRC non-connected state, and the predetermined operation is cell reselection. The method is performed by the terminal and includes step 51. Step 51 includes at least one of the following:
adjusting, according to the offset indication information, a measurement result parameter Srxlev in a cell reselection measurement criterion, where an adjusted Srxlev is a sum of the Srxlev before adjustment and an RSRP offset indicated by the offset indication information;
adjusting, according to the offset indication information, a measurement result parameter Squal in a cell reselection measurement criterion, where an adjusted Squal is a sum of the Squal before adjustment and an RSRQ offset indicated by the offset indication information;
adjusting, according to the offset indication information, a threshold parameter SIntraSearchP in a cell reselection measurement criterion, where an adjusted SIntraSearchP is a difference between the SIntraSearchP before adjustment and an RSRP offset indicated by the offset indication information; and
adjusting, according to the offset indication information, a threshold parameter SIntraSearchQ in the cell reselection measurement criterion, where an adjusted SIntraSearchQ is a difference between the SIntraSearchQ before adjustment and an RSRQ offset indicated by the offset indication information.

Exemplarily, the measurement result, obtained based on the cell reselection measurement criterion, using NCD-SSB is compensated. Here, the compensation may include adjustment of the cell reselection measurement criterion based on the offset indication information.

Exemplarily, after adjustment, it may be:

$$Srxlev + rsrpOffsetNCDSSB > SIntraSearchP and Squal + rsrqOffsetNCDSSB > SIntraSearchQ ;$$

$$or ,$$

$$Srxlev = {Q}_{rxlevmeas} - ( {Q}_{rxlevmin} + {Q}_{rxlevminoffset} ) - {P}_{compensation} - {Qoffset}_{temp} + rsrpOffsetNCDSSB ;$$

$$Squal = {Q}_{qualmeas} - ( {Q}_{qualmin} + {Q}_{qualminoffset} ) - {Q}_{offsettemp} + rsrqOffsetNCDSSB ,$$

where rsrpOffsetNCDSSB is the RSRP offset, and rsrqOffsetNCDSSB is the RSRQ offset.

It should be noted that those skilled in the art can understand that the methods according to some embodiments of this disclosure may be executed independently, or together with some methods according to some other embodiments of this disclosure or some methods

In some embodiments, the terminal is in the RRC non-connected state, and the predetermined operation is cell ranking.

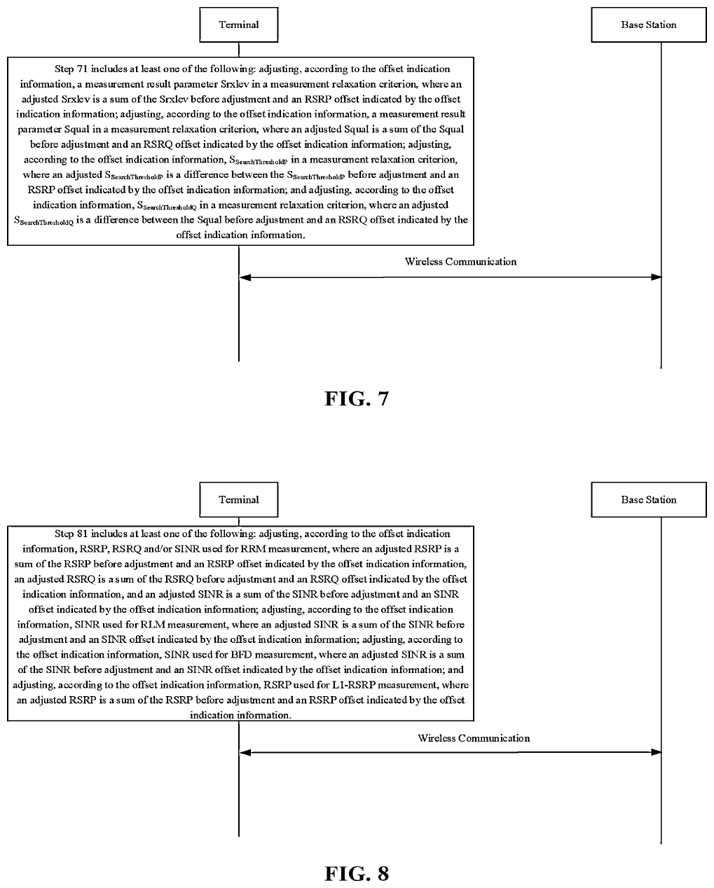

As shown in FIG. 6, this embodiment provides a method for performing a predetermined operation based on the NCD-SSB measurement result, where the terminal is in the RRC non-connected state, and the predetermined operation is cell ranking. The method is performed by the terminal and includes step 61. Step 61 includes at least one of the following:
adjusting, according to the offset indication information, a measurement result parameter Rₛ in R-ranking criterion, where an adjusted R, is a sum of the R, before adjustment and an RSRP offset indicated by the offset indication information;
adjusting, according to the offset indication information, a measurement result parameter Rₙ in R-ranking criterion, where an adjusted Rn is a sum of the R, before adjustment and an RSRQ offset indicated by the offset indication information;
adjusting, according to the offset indication information, a first reference parameter in R-ranking criterion, where an adjusted first reference parameter is a sum of the first reference parameter before adjustment and an RSRP offset indicated by the offset indication information; and
adjusting, according to the offset indication information, a second reference parameter in R-ranking criterion, where an adjusted second reference value parameter is a sum of the second reference value parameter before adjustment and an RSRQ offset indicated by the offset indication information.

In some embodiments, when performing intra-frequency and same-priority inter-frequency cell reselection, the terminal ranks cells satisfying S-criterion and determines the cell with the highest ranking as the target cell for reselection.

Exemplarily, when performing ranking and comparing the measurement results based on NCD-SSB, the following is considered:
Rₛ+rsrpOffsetNCDSSB, where Rₛ may be the first reference parameter,
Rₙ+rsrqOffsetNCDSSB, where Rₙ may be the second reference parameter;
or,

$${R}_{s} = {Q}_{meas , s} + {Q}_{hyst} - {Q}_{offsettemp} + rsrpOffsetNCDSSB ,$$

$${R}_{n} = {Q}_{meas , n} - {Q}_{offset} - {Q}_{offsettemp} + rsrqOffsetNCDSSB ,$$

where rsrpOffsetNCDSSB is the RSRP offset, and rsrqOffsetNCDSSB is the RSRQ offset.

It should be noted that those skilled in the art can understand that the methods according to some embodiments of this disclosure may be executed independently, or together with some methods according to some other embodiments of this disclosure or some methods in related art.

In some embodiments, the terminal is in the RRC non-connected state, and the predetermined operation is measurement relaxation.

As shown in FIG. 7, this embodiment provides a method for performing a predetermined operation based on the NCD-SSB measurement result, where the terminal is in the RRC non-connected state, and the predetermined operation is measurement relaxation. The method is performed by the terminal and includes step 71. Step 71 includes at least one of the following:
adjusting, according to the offset indication information, a measurement result parameter Srxlev in a measurement relaxation criterion, where an adjusted Srxlev is a sum of the Srxlev before adjustment and an RSRP offset indicated by the offset indication information;
adjusting, according to the offset indication information, a measurement result parameter Squal in a measurement relaxation criterion, where an adjusted Squal is a sum of the Squal before adjustment and an RSRQ offset indicated by the offset indication information;
adjusting, according to the offset indication information, S_{SearchThresholdP} in a measurement relaxation criterion, where an adjusted S_{SearchThresholdP} is a difference between the S_{SearchThresholdP} before adjustment and an RSRP offset indicated by the offset indication information; and
adjusting, according to the offset indication information, S_{SearchThresholdQ} in a measurement relaxation criterion, where an adjusted S_{SearchThresholdQ} is a difference between the S_{SearchThresholdQ} before adjustment and an RSRQ offset indicated by the offset indication information.

In some embodiments, the terminal with measurement relaxation capability makes decision of performing low mobility criterion and non-cell-edge criterion. After adjustment of the measurement relaxation criterion:

$$Srxlev + rsrpOffsetNCDSSB > {S}_{SearchThresholdP} and Squal + rsrqOffsetNCDSSB > {S}_{SearchThresholdQ} ;$$

$$or ,$$

$$Srxlev = {Q}_{rxlevmeas} - ( {Q}_{rxlevmin} + {Q}_{rxlevminoffset} ) - {P}_{compensation} - {Qoffset}_{temp} + rsrpOffsetNCDSSB ;$$

$$Squal = {Q}_{qualmeas} - ( {Q}_{qualmin} + {Q}_{qualminoffset} ) - {Qoffset}_{temp} + rsrqOffsetNCDSSB ,$$

where rsrpOffsetNCDSSB is the RSRP offset, and rsrqOffsetNCDSSB is the RSRQ offset.

It should be noted that those skilled in the art can understand that the methods according to some embodiments of this disclosure may be executed independently, or together with some methods according to some other embodiments of this disclosure or some methods in related art.

In some embodiments, the terminal is in the RRC connected state.

As shown in FIG. 8, this embodiment provides a method for performing a predetermined operation based on the NCD-SSB measurement result, where the terminal is in the RRC connected state. The method is performed by the terminal and includes step 81. Step 81 includes at least one of the following:
adjusting, according to the offset indication information, RSRP, RSRQ and/or SINR used for RRM measurement, where an adjusted RSRP is a sum of the RSRP before adjustment and an RSRP offset indicated by the offset indication information, an adjusted RSRQ is a sum of the RSRQ before adjustment and an RSRQ offset indicated by the offset indication information, and an adjusted SINR is a sum of the SINR before adjustment and an SINR offset indicated by the offset indication information;
adjusting, according to the offset indication information, SINR used for RLM measurement, where an adjusted SINR is a sum of the SINR before adjustment and an SINR offset indicated by the offset indication information;
adjusting, according to the offset indication information, SINR used for BFD measurement, where an adjusted SINR is a sum of the SINR before adjustment and an SINR offset indicated by the offset indication information; and
adjusting, according to the offset indication information, RSRP used for L1-RSRP measurement, where an adjusted RSRP is a sum of the RSRP before adjustment and an RSRP offset indicated by the offset indication information.

In some embodiments, the base station sends NCD-SSB configuration information to the terminal, where the configuration information may include the offset indication information. After receiving the configuration information, the terminal adjusts the RSRP and/or RSRQ used for RRM measurement according to the offset indication information, where an adjusted RSRP is a sum of the RSRP before adjustment and an RSRP offset indicated by the offset indication information, and an adjusted RSRQ is a sum of the RSRQ before adjustment and an RSRQ offset indicated by the offset indication information.

In some embodiments, the base station sends NCD-SSB configuration information to the terminal, where the configuration information may include the offset indication information. After receiving the configuration information, the terminal adjusts the SINR used for RLM measurement according to the offset indication information, where an adjusted SINR is a sum of the SINR before adjustment and an SINR offset indicated by the offset indication information.

In some embodiments, the base station sends NCD-SSB configuration information to the terminal, where the configuration information may include the offset indication information. After receiving the configuration information, the terminal adjusts the SINR used for BFD measurement according to the offset indication information, where an adjusted SINR is a sum of the SINR before adjustment and an SINR offset indicated by the offset indication information.

In some embodiments, the base station sends NCD-SSB configuration information to the terminal, where the configuration information may include the offset indication information. After receiving the configuration information, the terminal adjusts the RSRP used for L1-RSRP measurement according to the offset indication information, where an adjusted RSRP is a sum of the RSRP before adjustment and an RSRP offset indicated by the offset indication information.

It should be noted that those skilled in the art can understand that the methods according to some embodiments of this disclosure may be executed independently, or together with some methods according to some other embodiments of this disclosure or some methods

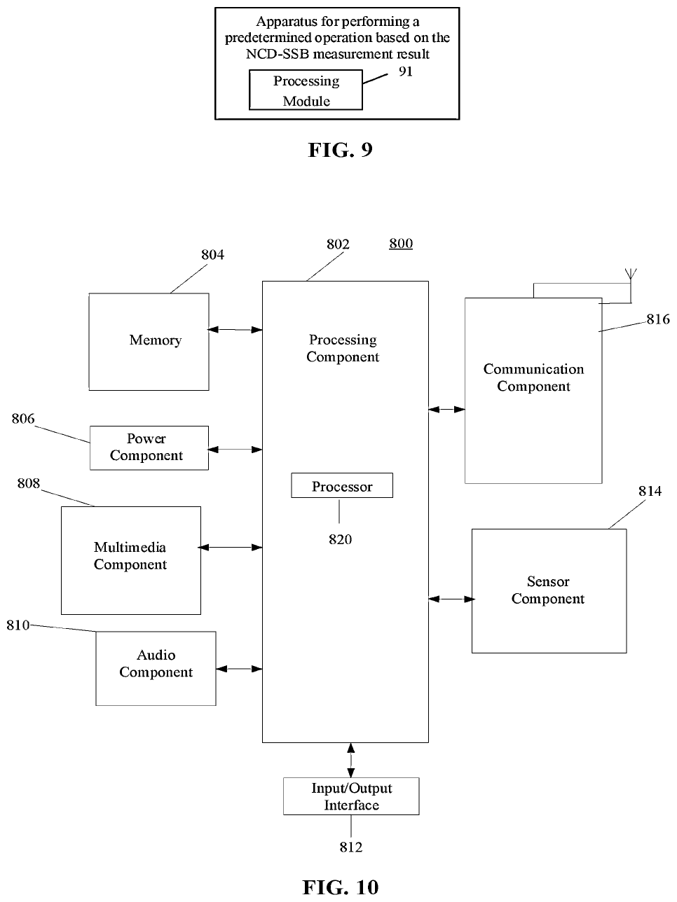

As shown in FIG. 9, an embodiment of this disclosure provides an apparatus for performing a predetermined operation based on the NCD-SSB measurement result, where the apparatus includes:
a processing module 91, configured to adjust, according to offset indication information, a predetermined parameter for performing a predetermined operation based on the measurement result;
where the measurement result is a result obtained by performing a measurement operation based on the NCD-SSB; and the offset indication information is information indicating a measurement offset between a measurement operation performed based on a CD-SSB and the measurement operation performed based on the NCD-SSB.

It should be noted that those skilled in the art can understand that the methods according to some embodiments of this disclosure may be executed independently, or together with some methods according to some other embodiments of this disclosure or some methods in related art.

An embodiment of this disclosure provides a communication device, which includes:
a processor; and
a memory for storing instructions executable by the processor;
where the processor, upon running the executable instructions, is configured to implement the method according to any embodiment of this disclosure.

In some embodiments, the memory may include various types of storage media, which are non-transitory computer storage media, and can continue to memorize and store information thereon after the communication device is powered off.

The processor can be connected to the memory through a bus or the like, and is used to read the executable program stored in the memory.

An embodiment of the present disclosure further provides a computer storage medium, wherein the computer storage medium stores a computer executable program, and when the executable program is executed by a processor, the method of any embodiment of the present disclosure is implemented.

Regarding the apparatus in the foregoing embodiments, the specific manner in which each module executes operations has been described in detail in the embodiments related to the method, and will not be described in detail here.

As show in FIG. 10, an embodiment of this disclosure provides a structure of a terminal.

Referring to the terminal 800 shown in FIG. 10, this embodiment provided the terminal 800, which may be a mobile phone, a computer, a digital broadcast terminal, a messaging device, a game console, a tablet device, a medical device, a fitness device, a personal digital assistant, and the like.

Referring to FIG. 10, the terminal 800 may include one or more of the following components: processing component 802, memory 804, power component 806, multimedia component 808, audio component 810, input/output (I/O) interface 812, sensor component 814, and communication component 816.

The processing component 802 generally controls the overall operation of the terminal 800, such as operations associated with display, phone calls, data communications, camera operations, and recording operations. The processing component 802 may include one or more processors 620 to execute instructions to perform all or some of the steps of the methods described above. Additionally, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support operations at the device 800. Examples of such data include instructions, contact data, phonebook data, messages, pictures, videos, and the like for any application or method operating on the terminal 800. The memory 804 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 806 provides power to various components of the terminal 800. The power components 806 may include a power management system, one or more power sources, and other components associated with generating, managing, and distributing power to the terminal 800.

The multimedia component 808 includes a screen that provides an output interface between the terminal 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 808 includes a front camera and/or a rear camera. When the device 800 is in an operation mode, such as a shooting mode or a video mode, the front camera and/or the rear camera may receive external multimedia data. Each of the front and rear cameras may be a fixed optical lens system or have focal length and optical zoom capability.

The audio component 810 is configured to output and/or input audio signals. For example, the audio component 810 includes a microphone (MIC) that is configured to receive external audio signals when the terminal 800 is in operating modes, such as calling mode, recording mode, and voice recognition mode. The received audio signal may be further stored in the memory 804 or transmitted via the communication component 816. In some embodiments, the audio component 810 also includes a speaker for outputting audio signals.

The I/O interface 812 provides an interface between the processing component 802 and a peripheral interface module, which may be a keyboard, a click wheel, a button, or the like. These buttons may include, but are not limited to: home button, volume buttons, start button, and lock button.

The sensor assembly 814 includes one or more sensors for providing state assessments of various aspects of the terminal 800. For example, the sensor assembly 814 can detect the open/closed state of the device 800, the relative positioning of components, such as the display and keypad of the terminal 800. The sensor assembly 814 can also detect a change in the position of the terminal 800 or a component of the terminal 800, the presence or absence of user contact with the terminal 800, the orientation or acceleration/deceleration of the terminal 800, and the temperature change of the terminal 800. The sensor assembly 814 may include a proximity sensor configured to detect the presence of nearby objects in the absence of any physical contact. The sensor assembly 814 may also include a light sensor, such as a CMOS or CCD image sensor, for use in imaging applications. In some embodiments, the sensor assembly 814 may also include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access wireless networks based on communication standards, such as WiFi, 2G or 3G, or a combination thereof. In some embodiments, the communication component 816 receives broadcast signals or broadcast related information from an external broadcast management system via a broadcast channel. In some embodiments, the communication component 816 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the terminal 800 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component, which are configured to perform the forgoing methods.

In some embodiments, there is also provided a non-transitory computer-readable storage medium including instructions, such as the memory 804 including instructions, executable by the processor 820 of the terminal 800 to perform the method described above. For example, the non-transitory computer-readable storage medium may be ROM, random access memory (RAM), CD-ROM, magnetic tape, floppy disk, optical data storage device, and the like.

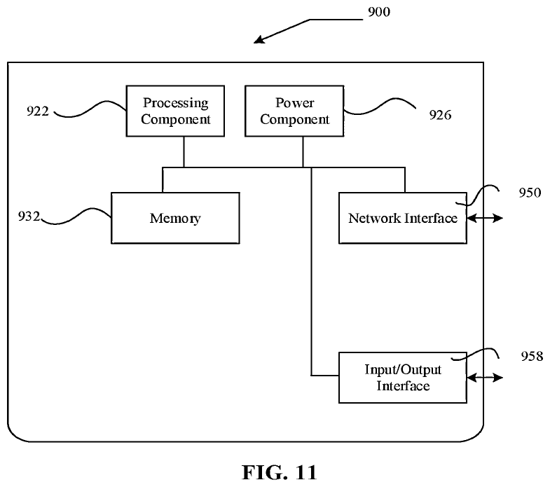

As shown in FIG. 11, an embodiment of this disclosure illustrates a structure of a base station. For example, the base station 900 may be provided as a network side device. Referring to FIG. 11, the base station 900 includes a processing component 922, which further includes one or more processors; and a memory resource represented by a memory 932, which is used for storing instructions executable by the processing component 922, such as application programs. The application programs stored in memory 932 may include one or more modules each corresponding to a set of instructions. In addition, the processing component 922 is configured to execute instructions, so as to perform any of the forgoing methods applied to the base station.

The base station 900 may also include a power component 926 configured to perform power management of the base station 900, a wired or wireless network interface 950 configured to connect the base station 900 to a network, and an I/O interface 958. The base station 900 can operate based on an operating system stored in the memory 932, such as Windows Server™, Mac OS X™, Unix™, Linux™, FreeBSD™ or the like.

Other embodiments of the invention will be readily apparent to those skilled in the art from consideration of the specification and practice of the invention disclosed herein. This disclosure is intended to cover any modification, use or adaptation of the present invention, which follow the general principles of the present invention and include common knowledge or conventional technical means in the art not disclosed in this disclosure. The specification and examples are to be considered exemplary only, with a true scope and spirit of the invention being indicated by the following claims.

It should be understood that the present invention is not limited to the precise constructions which have been described above and shown in the accompanying drawings, and various modifications and changes may be made without departing from the scope thereof. The scope of the invention is limited only by the appended claims.

1. A method for performing a predetermined operation based on a measurement result of a non-cell defining synchronization signal block (NCD-SSB), being performed by a terminal, the method comprising:
adjusting, according to offset indication information, a predetermined parameter for performing the predetermined operation based on the measurement result,
wherein the measurement result is obtained by performing a measurement operation based on the NCD-SSB, and
wherein the offset indication information is indicative of a measurement offset between a measurement operation performed based on a cell-defining synchronization signal block (CD-SSB) and the measurement operation performed based on the NCD-SSB.

2. The method according to claim 1, wherein the predetermined parameter comprises at least one of following:
a measurement result parameter of the measurement result;
a threshold parameter of an execution condition used for performing the predetermined operation; and
a reference parameter of an execution condition used for performing the predetermined operation.

3. The method according to claim 1, wherein the offset indication information comprises at least one of following:
information on a power offset between the measurement operation performed based on the CD-SSB and the measurement operation performed based on the NCD-SSB;
information on a reference signal received power (RSRP) offset between the measurement operation performed based on the CD-SSB and the measurement operation performed based on the NCD-SSB;
information on a reference signal received quality (RSRQ) offset between the measurement operation performed based on the CD-SSB and the measurement operation performed based on the NCD-SSB; and
information on a signal to interference plus noise ratio (SINR) offset between the measurement operation performed based on the CD-SSB and the measurement operation performed based on the NCD-SSB.

4. The method according to claim 3, further comprising at least one of following:
determining the information on the RSRP offset according to the information on the power offset;
determining the information on the RSRQ offset according to the information on the power offset; and
determining the information on the SINR offset according to the information on the power offset.

5. The method according to claim 1, wherein the terminal is in a radio resource control (RRC) non-connected state, and the predetermined operation is cell selection.

6. The method according to claim 5, wherein said adjusting, according to the offset indication information, the predetermined parameter for performing the predetermined operation based on the measurement result comprises at least one of following:
adjusting, according to the offset indication information, a measurement result parameter Srxlev in S-criterion used for the cell selection, wherein an adjusted Srxlev is a sum of the Srxlev before adjustment and an RSRP offset indicated by the offset indication information;
adjusting, according to the offset indication information, a measurement result parameter Squal in S-criterion used for the cell selection, wherein an adjusted Squal is a sum of the Squal before adjustment and an RSRQ offset indicated by the offset indication information;
adjusting, according to the offset indication information, a first threshold parameter in S-criterion used for the cell selection, wherein an adjusted first threshold parameter is a difference between the first threshold parameter before adjustment and an RSRP offset indicated by the offset indication information; and
adjusting, according to the offset indication information, a second threshold parameter in S-criterion used for the cell selection, wherein an adjusted second threshold parameter is a difference between the second threshold parameter before adjustment and an RSRQ offset indicated by the offset indication information.

7. The method according to claim 1, wherein the terminal is in an RRC non-connected state, and the predetermined operation is cell reselection.

8. The method according to claim 7, wherein said adjusting, according to the offset indication information, the predetermined parameter for performing the predetermined operation based on the measurement result comprises at least one of following:
adjusting, according to the offset indication information, a measurement result parameter Srxlev in a cell reselection measurement criterion, wherein an adjusted Srxlev is a sum of the Srxlev before adjustment and an RSRP offset indicated by the offset indication information;
adjusting, according to the offset indication information, a measurement result parameter Squal in a cell reselection measurement criterion, wherein an adjusted Squal is a sum of the Squal before adjustment and an RSRQ offset indicated by the offset indication information;
adjusting, according to the offset indication information, a threshold parameter SIntraSearchP in a cell reselection measurement criterion, wherein an adjusted SIntraSearchP is a difference between the SIntraSearchP before adjustment and an RSRP offset indicated by the offset indication information; and
adjusting, according to the offset indication information, a threshold parameter SIntraSearchQ in the cell reselection measurement criterion, wherein an adjusted SIntraSearchQ is a difference between the SIntraSearchQ before adjustment and an RSRQ offset indicated by the offset indication information.

9. The method according to claim 1, wherein the terminal is in an RRC non-connected state, and the predetermined operation is cell ranking.

10. The method according to claim 9, wherein said adjusting, according to the offset indication information, the predetermined parameter for performing the predetermined operation based on the measurement result comprises at least one of following:
adjusting, according to the offset indication information, a measurement result parameter Rs in an R-ranking criterion, wherein an adjusted Rs is a sum of the Rs before adjustment and an RSRP offset indicated by the offset indication information;
adjusting, according to the offset indication information, a measurement result parameter Rn in an R-ranking criterion, wherein an adjusted Rn is a sum of the Rn before adjustment and an RSRQ offset indicated by the offset indication information;
adjusting, according to the offset indication information, a first reference parameter in an R-ranking criterion, wherein an adjusted first reference parameter is a sum of the first reference parameter before adjustment and an RSRP offset indicated by the offset indication information; and
adjusting, according to the offset indication information, a second reference parameter in an R-ranking criterion, wherein an adjusted second reference parameter is a sum of the second reference parameter before adjustment and an RSRQ offset indicated by the offset indication information.

11. The method according to claim 1, wherein the terminal is in an RRC non-connected state, and the predetermined operation is a measurement relaxation operation.

12. The method according to claim 11, wherein said adjusting, according to the offset indication information, the predetermined parameter for performing the predetermined operation based on the measurement result comprises at least one of following:
adjusting, according to the offset indication information, a measurement result parameter Srxlev in a measurement relaxation criterion, wherein an adjusted Srxlev is a sum of the Srxlev before adjustment and an RSRP offset indicated by the offset indication information;
adjusting, according to the offset indication information, a measurement result parameter Squal in a measurement relaxation criterion, wherein an adjusted Squal is a sum of the Squal before adjustment and an RSRQ offset indicated by the offset indication information;
adjusting, according to the offset indication information, S_{SearchThresholdP} in a measurement relaxation criterion, wherein an adjusted S_{SearchThresholdP} is a difference between the S_{SearchThresholdP} before adjustment and an RSRP offset indicated by the offset indication information; and
adjusting, according to the offset indication information, S_{SearchThresholdQ} in a measurement relaxation criterion, wherein an adjusted S_{SearchThresholdQ} is a difference between the S_{SearchThresholdO} before adjustment and an RSRQ offset indicated by the offset indication information.

13. The method according to claim 1, wherein the terminal is in an RRC connected state.

14. The method according to claim 13, wherein said adjusting, according to the offset indication information, the predetermined parameter for performing the predetermined operation based on the measurement result comprises at least one of following:
adjusting, according to the offset indication information, RSRP, RSRQ and/or SINR used for radio resource management (RRM) measurement, wherein an adjusted RSRP is a sum of the RSRP before adjustment and an RSRP offset indicated by the offset indication information, an adjusted RSRQ is a sum of the RSRQ before adjustment and an RSRQ offset indicated by the offset indication information, and an adjusted SINR is a sum of the SINR before adjustment and an SINR offset indicated by the offset indication information;
adjusting, according to the offset indication information, SINR used for radio link monitoring (RLM) measurement, wherein an adjusted SINR is a sum of the SINR before adjustment and an SINR offset indicated by the offset indication information;
adjusting, according to the offset indication information, SINR used for beam failure detection (BFD) measurement, wherein an adjusted SINR is a sum of the SINR before adjustment and an SINR offset indicated by the offset indication information; and
adjusting, according to the offset indication information, RSRP used for L1-RSRP measurement, wherein an adjusted RSRP is a sum of the RSRP before adjustment and an RSRP offset indicated by the offset indication information.

15-16. (canceled)

17. A computer storage medium, storing computer-executable instructions which, upon being executed by a processor, execute a method for performing a predetermined operation based on a measurement result of a non-cell defining synchronization signal block (NCD-SSB), wherein the method comprises:
adjusting, according to offset indication information, a predetermined parameter for performing the predetermined operation based on the measurement result,
wherein the measurement result is obtained by performing a measurement operation based on the NCD-SSB, and
wherein the offset indication information is indicative of a measurement offset between a measurement operation performed based on a cell-defining synchronization signal block (CD-SSB) and the measurement operation performed based on the NCD-SSB.

18. A communication device, comprising:
a memory; and
a processor connected to the memory and configured to execute computer-executable instructions stored in the memory,
wherein the processor is configured to:
adjust, according to offset indication information, a predetermined parameter for performing a predetermined operation based on a measurement result of a non-cell defining synchronization signal block (NCD-SSB),
wherein the measurement result is obtained by performing a measurement operation based on the NCD-SSB, and
wherein the offset indication information is indicative of a measurement offset between a measurement operation performed based on a cell-defining synchronization signal block (CD-SSB) and the measurement operation performed based on the NCD-SSB.

19. The communication device according to claim 18, wherein the predetermined parameter comprises at least one of following:
a measurement result parameter of the measurement result;
a threshold parameter of an execution condition used for performing the predetermined operation; and
a reference parameter of an execution condition used for performing the predetermined operation.

20. The communication device according to claim 18, wherein the offset indication information comprises at least one of following:
information on a power offset between the measurement operation performed based on the CD-SSB and the measurement operation performed based on the NCD-SSB;
information on a reference signal received power (RSRP) offset between the measurement operation performed based on the CD-SSB and the measurement operation performed based on the NCD-SSB;
information on a reference signal received quality (RSRQ) offset between the measurement operation performed based on the CD-SSB and the measurement operation performed based on the NCD-SSB; and
information on a signal to interference plus noise ratio (SINR) offset between the measurement operation performed based on the CD-SSB and the measurement operation performed based on the NCD-SSB.

21. The communication device according to claim 20, wherein the processor is configured to perform at least one of following:
determining the information on the RSRP offset according to the information on the power offset;
determining the information on the RSRQ offset according to the information on the power offset; and
determining the information on the SINR offset according to the information on the power offset.
